(19) United States
(12) Patent Application Publication
(10) Pub. No.: US 2022/0006291 A1
(43) Pub. Date: Jan. 6, 2022

(54) SWITCHING DEVICE FOR SAFELY DISCONNECTING AN ELECTRICAL LOAD FROM A POWER SUPPLY NETWORK AND A SAFETY SWITCHING SYSTEM

(71) Applicant: Phoenix Contact GmbH & Co. KG, Blomberg (DE)

(72) Inventors: Elmar SCHAPER, Lügde (DE); Bernd SCHULZ, Höxter (DE)

(21) Appl. No.: 17/279,470

(22) PCT Filed: Sep. 25, 2019
(86) PCT No.: PCT/EP2019/075894

§ 371 Date: Mar. 24, 2021

(30) Foreign Application Priority Data
Sep. 28, 2018 (DE) 102018124118.6

(51) Int. Cl. H02J 3/14; H02H 7/26

(52) U.S. Cl. CPC H02J 3/14; H02H 7/26

(57) ABSTRACT

A switching apparatus for safely disconnecting an electrical load from a power supply network and to facilitate safe disconnection in the event of failure of a supply voltage thereof, includes an energy storage device which, in the event of failure of the supply voltage of a control unit, provides the energy for generating switching signals for a first electromechanical switch, a second electromechanical switch and a semiconductor switch. In order to be able to detect the failure of the supply voltage, a detector and signaling device is provided which is configured to detect discharging of the energy storage device and to supply a notification signal to the control unit signaling the discharging of the energy storage device to the control unit. In response to the notification signal, the control unit causes the electrical load to be disconnected from the power supply network in a safe and terminal-friendly manner.

### FIELD

The invention relates to a switching apparatus, in particular to a motor switch or motor starter, and to a safety switching system for safely disconnecting an electrical load from a power supply network.

### BACKGROUND

In switching apparatus that use hybrid switches in addition to electromechanical switches, there is a risk that in an event of failure of the supply voltage of the switching apparatus, the output stage cannot be disconnected in a controlled manner. This is why storage capacitors are implemented in the input circuit of the device's power supply in such switching apparatus, which provide the necessary power for sequentially disconnecting the electromechanical switches and the hybrid switches in the event of a failure of the supply voltage. Usually, such a storage capacitor is dimensioned such that it allows to sequentially switch off the electromechanical switches and hybrid switches for a single time, when the supply voltage fails.

Such a switching apparatus is known from EP 2 898 521 A1, for example, and is used to control the energy supply to a downstream connected electrical motor. The prior art switching apparatus comprises a control unit, a power supply connection, a power supply unit and a current path connected to a power supply network, which comprises a first electromechanical switch and a parallel circuit of a second electromechanical switch with a semiconductor switch connected in series to the first switch. The control unit emits the switching signals for the switches, and the control unit obtains the energy for the switching signals via the power supply unit. Furthermore, the switching apparatus comprises an energy storage and a measuring device connected to the control unit, and the control unit uses the measuring device to be able to monitor the energy supplied to the switching apparatus via the power supply connection. The control unit is furthermore configured such that, if the energy supply monitored by the measuring device falls into a critical range, it is able, by using the energy from the energy storage, to control the semiconductor switches and the electromechanical switches and the semiconductor switch accordingly in order allow to disconnect an electrical load from the power supply network in a terminal-friendly manner.

### SUMMARY

The present invention is based on the object of providing a switching apparatus and a safety switching system for safely disconnecting an electrical load from a power supply network, which can be manufactured more cost-efficiently and can be operated in a more energy-saving manner compared to prior art switching apparatus.

What can be considered as a key idea of the invention is to dispense with an expensive and complex measuring device, the measurement result of which has to be continuously evaluated by a control unit, so that in particular an energy-saving solution can be implemented.

The aforementioned technical problem is solved by the features of claim 1, on the one hand.

Accordingly, a switching apparatus is provided for safely disconnecting an electrical load from a power supply network, which comprises the following features:

a first connection device to which a power supply network for providing a supply voltage for an electrical load can be connected;

a second connection device to which an electrical load can be connected;

a third connection device to which a power supply source for providing a supply voltage for the switching apparatus can be connected;

at least one current path connected between the first and second connection devices, the at least one current path including a first electromechanical switch and, connected in series with the first electromechanical switch, a parallel circuit of a second electromechanical switch connected in parallel to a semiconductor switch;

a power supply unit electrically connected to the third connection device;

an energy storage device electrically connected to the third connection device in such a way that the energy storage device can be charged by a supply voltage that can be applied to the third connection device;

a control unit electrically connected to the power supply unit; wherein the control unit is configured to output a respective switching signal for the first electromechanical switch, the second electromechanical switch, and the semiconductor switch, wherein the control unit receives power for generating the switching signals via the power supply unit;

a detector and signaling device configured to detect discharging of the energy storage device and to supply a notification signal to the control unit signaling the control unit that the energy storage device is discharging, wherein the control unit is configured to be responsive to this notification signal by using the energy stored in the energy storage device to first switch the semiconductor switch to an electrically conductive state, then to open the second electromechanical switch, then to switch the semiconductor switch to an electrically non-conductive state, and then to open the first electromechanical switch

Such a switching apparatus can be operated in a more energy-saving manner than the switching apparatus described in EP 2 898 521 A1.

This is in particular achieved through the fact that the control unit receives a binary signal from the detector and signaling device, which signal indicates that the energy storage device is discharging or is not discharging. Continuous monitoring of a supply voltage of the switching apparatus by the control unit is not necessary any more.

Expediently, a voltage limiting device is connected to the energy storage device and configured to limit the voltage applied to the energy storage device to a predetermined voltage value, and the energy storage device will discharge when a supply voltage applied to the third connection device falls below the predetermined voltage value applied to the energy storage device.

It should be noted here, that during normal operation of the switching apparatus, the predetermined voltage applied to the energy storage device is always lower than the supply voltage of the switching apparatus applied to the third connection device.

Expediently, the first connection device comprises a ground terminal and an operating potential terminal. Furthermore, the voltage limiting device comprise a Zener diode and an electrical resistor, the Zener diode being connected in parallel to the energy storage device. The anode terminal of the Zener diode is connected to the ground terminal and the cathode terminal of the Zener diode is connected to a terminal of the electrical resistor, while the other terminal of the electrical resistor is associated with the operating potential terminal.

According to a cost-effective solution it is contemplated that the detector and signaling device includes a coupling element which is connected to the energy storage device, to an input of the control unit, and to an input of the power supply unit, and that the detector and signaling device supplies a binary notification signal.

Expediently, the coupling element is an optocoupler which comprises an optical transmitter connected between the energy storage device and the input of the power supply unit, and an optical receiver connected to the input of the control unit.

In order to be able to make the disconnection of an electrical load from the power supply network more reliable, the switching apparatus may comprise a further current path connected between the first and second connection devices, which, too, includes a first electromechanical switch and, connected in series with the first electromechanical switch, a second electromechanical switch and a semiconductor switch connected in parallel to each other. In this case, the control unit is configured to output a respective switching signal for the first electromechanical switch, the second electromechanical switch, and the semiconductor switch of the further current path, and the control unit is furthermore configured, in relation to the further current path, to be responsive to the notification signal from the detector and signaling device by using the energy stored in the energy storage device to first switch the semiconductor switch to an electrically conductive state, then to open the second electromechanical switch, then to switch the semiconductor switch to an electrically non-conductive state, and then to open the first electromechanical switch.

On the other hand, the technical problem stated above is solved with the features of claim 7.

Accordingly, a safety switching system is provided for safely disconnecting an electrical load from a power supply network, which comprises at least one switching apparatus as described above, an external power supply source that can be connected to the third connection device of the switching apparatus via an external switching device or can be disconnected from the third connection device of the switching apparatus.

According to an expedient and flexible embodiment it is suggested to connect in parallel a plurality of switching apparatus as described above to the power supply source via the external switching device, and in this case each switching apparatus includes a decoupling diode with an anode terminal thereof connected to the third connection device, and with a cathode terminal thereof connected to the power supply unit of the respective switching apparatus. In this way, the energy storage device of each switching apparatus is prevented from discharging in the direction of the power supply source.

### BRIEF DESCRIPTION OF THE DRAWINGS

The invention will now be explained in more detail by way of an exemplary embodiment in conjunction with the accompanying drawings, wherein:

FIG. 1 shows an exemplary safety switching system including a switching apparatus according to the invention; and

FIG. 2 shows another exemplary safety switching system which comprises two switching apparatus according to the invention.

### DETAILED DESCRIPTION

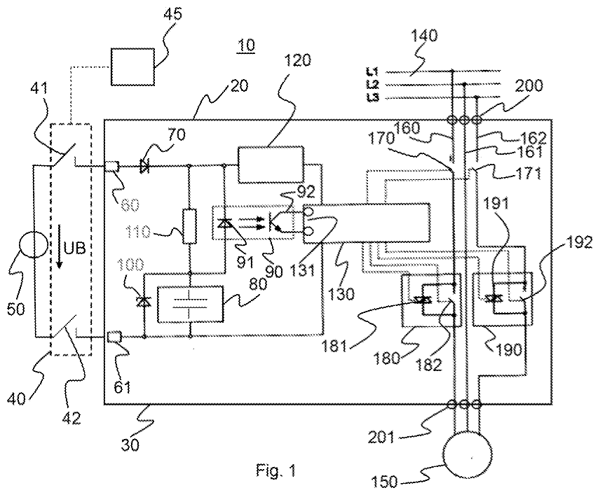

FIG. 1 shows an exemplary switching apparatus 20 for safely disconnecting an electrical load 150 from a power supply network 140. The switching apparatus 20 is in particular configured as a motor switch. The electrical load 150 may be an electrical motor, in particular a three-phase motor. The power supply network 140 may be a three-phase power supply network, for example.

The switching apparatus 20 is preferably accommodated in a housing 30 and comprises a first connection device 200 to which the power supply network 140 can be connected to provide a supply voltage for the electrical load 150. If this is a three-phase power supply network, the first connection device 200 will accordingly have three terminals. Furthermore, the switching apparatus 20 comprises a second connection device 201 to which the electrical load 150 can be connected. If this is a three-phase load, the second connection device will have three terminals. In addition, the switching apparatus 20 comprises a third connection device including an operating potential terminal 60 and a ground terminal 61, to which a power supply source 50 can be connected for providing a supply voltage UB for the switching apparatus 20.

As shown in FIG. 1, the power supply source 50 can be connected to or disconnected from the third connection device 60, 61 via a switching device 40. Switching device 40 may be a two-channel switching device including one switch 41 associated with the operating potential terminal 60 and a further switch 42 associated with the ground terminal 61. Switching device 40 can be actuated, for example, via an emergency stop switch 45 in order to enable safe disconnection of the electrical load 150. For example, the power supply source 50 supplies a DC supply voltage UB of 24 V, for example.

At least one current path 160 is connected between the first connection device 200 and the second connection device 201, which includes a first electromechanical switch 170 and, connected in series with the first electromechanical switch 170, a parallel or hybrid circuit 180 comprising a second electromechanical switch 182 and a semiconductor switch 181. In the illustrated example, a second current path 161 is provided between the first connection device 200 and the second connection device 201, which is implemented as a continuous line. In addition, a third current path 162 may be provided which, similar to the first current path, includes a first electromechanical switch 171 and, connected in series thereto, a parallel or hybrid circuit 190 comprising a second electromechanical switch 192 and a semiconductor switch 191.

Switching apparatus 20 furthermore comprises a power supply unit 120 which is electrically connected to the third connection device and is accommodated in the housing 30. A decoupling diode 70 may be connected between the operating potential terminal 60 of the third connection device and an input of the power supply unit 120, with the anode terminal thereof connected to the operating potential terminal 60, while the cathode terminal is connected to the input of power supply unit 120. The power supply unit 120 may be a switched-mode power supply unit which is configured to convert the supply voltage UB applied to the third connection device 60, 61 into a device-internal DC voltage of 5 V, for example. Power supply unit 120 is electrically connected to a control unit 130, which may be in the form of a microcontroller.

The control unit 130 is configured to output a respective switching signal for the first electromechanical switch 170, the second electromechanical switch 182, and the semiconductor switch 181. If the third current path 162 is provided, the control unit 130 is also configured to output a switching signal for the first electromechanical switch 171, the second electromechanical switch 192, and the semiconductor switch 191. Control unit 130 receives the power for generating the switching signals via power supply unit 120. As schematically illustrated in FIG. 1, the output of power supply unit 120 is connected to the ground terminal 61 of the third connection device via control unit 130.

In order to be able to supply switching signals for the electromechanical switches and the semiconductor switches in the event of failure or shutdown of the supply voltage UB applied to the third connection device 60, 61, an energy storage device 80 is provided inside the device, which is connected to the third connection device 60, 61 in such a way that the energy storage device 80 can be charged by the supply voltage UB that can be applied to the third connection device 60, 61. This ensures that even in the case of failure or shutdown of the supply voltage UB, there will still be sufficient energy available within the device to operate the control unit 130 via power supply unit 120. Energy storage device 80 is preferably provided in the form of a capacitor, which in particular is dimensioned so as to allow the electromechanical switches 170, 171, 182, 192 and the semiconductor switches 181 and 191 to be switched off sequentially in a defined manner, as will be explained further below, in order allow for a disconnection of the electrical load 150 from the power supply network 140 in a terminal-friendly way, that is to say so as to avoid arcing.

The switching apparatus 20 furthermore comprises a detector and signaling device 90 which is configured to detect discharging of the energy storage device 80 and to supply a notification signal to the control unit 130, which signals the control unit 130 that the energy storage device 80 is discharging. In order to enable safe and arc-free disconnection of the electrical load 150, the control unit is configured to respond to the notification signal by using the energy stored in the energy storage device 80 to first switch the semiconductor switches 181 and 191 in current paths 160 and 162 to an electrically conductive state, then to open the respective second electromechanical switch 182 and 192, respectively, then to switch the semiconductor switches 181 and 191 to an electrically non-conductive state, and then to open the first electromechanical switches 170 and 171, respectively.

A current limiting resistor 110 may be connected in series with the energy storage device 80, so as to have one terminal connected to the cathode terminal of decoupling diode 70 and its second terminal connected to the energy storage device 80. The energy storage device 80 is charged via decoupling diode 70 and current limiting resistor 110.

Appropriately, a voltage limiting device 100 may be connected to the energy storage device 80, which is configured to limit the voltage applied at the energy storage device 80 to a predetermined voltage value. The energy storage device 80 will discharge when the supply voltage UB applied to the third connection device 60, 61 has a voltage value which drops below the predetermined voltage value applied to the energy storage device 80.

The voltage limiting device is preferably a Zener diode 100 which is connected in parallel to the energy storage device 80, with the anode terminal of the Zener diode 100 being connected to the ground potential 61 and the cathode terminal of the Zener diode 100 being connected to the shared connection point of energy storage device 80 and current limiting resistor 110. Zener diode 100 limits the voltage at energy storage device 80 to a predetermined value, e.g. to 19 V. In this way it is ensured that in the case of voltage fluctuations of the supply voltage UB as applied at the third connection device 60, 61, the energy storage device 80 will not yet discharge. In this case, the energy storage device 80 will only discharge when the supply voltage UB at the third connection device drops below the predetermined voltage value of, for example, 19 V. This will in particular happen if the supply voltage UB fails or is switched off.

The detector and signaling device 90 may be configured as a coupling element which is connected to the energy storage device 80, to the input of power supply unit 120, and to an input 131 of control unit 130. As an output signal, the detector and signaling device 90 preferably supplies a binary notification signal which signals that the energy storage device 80 is either discharging or not discharging. The coupling element 90 may be an inductive or capacitive coupling element. In the present example, coupling element 90 is an optocoupler comprising an optical transmitter 91 which is connected between energy storage device 80 and the input of power supply unit 120 and which may be in the form of a laser diode or light emitting diode, for example. The anode terminal of optical transmitter 91 is connected to one terminal of the energy storage device 80, while the cathode terminal is connected to the input of power supply unit 120 and thus is associated with the operating potential terminal 60. The optocoupler 90 furthermore comprises an optical receiver 92 which is connected to the input 131 of control unit 130. In particular, the optical receiver 92 is in the form of a phototransistor, with the emitter and collector terminals thereof connected to the input 131 of control device 130. It should already be mentioned at this point that the switching apparatus 20, the power supply source 50, the switch device 40, and optionally also the emergency stop button 45 can be regarded as components of a safety switching system 10. Optionally, the power supply network 140 and the motor 150 may also be encompassed.

The operating principle of the switching apparatus 20 as shown in FIG. 1 will now be explained in more detail.

First, assuming that switches 41 and 42 are closed up to a point in time t1 so that the switching apparatus 20 is properly powered by a supply voltage UB. Accordingly, the control unit 130 ensures that the electromechanical switches 170, 171, 182, and 192 are switched so as to be in an electrically conductive state, while the semiconductor switches 181 and 191 are in an electrically non-conductive state. In this state, the motor 150 is connected to the power supply network 140. As already mentioned above, the energy storage device 80 is charged during normal operation, namely via decoupling diode 70 and current limiting resistor 110 in combination with Zener diode 100, to such an extent that a predetermined voltage, for example 19 V, is applied to the energy storage device 80. Since during normal operation the supply voltage UB at the third connection device 60, 61 is greater than the predetermined voltage of, e.g., 19V as applied to the charged energy storage device 80, the optical transmitter 91 blocks so that the energy storage device 80 is not discharging. Accordingly, the optical receiver 92 will also be non-conductive. This state corresponds to a logic zero which signals to the control unit 130 that the energy storage device is not discharging.

Assuming now that at time t1 the emergency stop switch 45 is actuated and switches 41 and 42 open. In response thereto, the supply voltage UB is disconnected from terminals 60 and 61 of the switching apparatus, the optical transmitter 91, for example in the form of a light-emitting diode, becomes conductive, and the energy storage device 80 discharges. This is because the potential at the cathode of the light-emitting diode suddenly drops below the potential at the anode terminal of the light-emitting diode. From this moment on, the energy storage device 80 will power the light-emitting diode 91, the power supply unit 120, and thereby the control unit 130. The light emitted by light-emitting diode 91 activates the optical receiver 92 which now becomes conductive. This status is reported to the control unit as a logical 1. In response to the logic 1 generated by the optical receiver 92 of the detector and signaling device 90, the control unit 130 will be aware that the energy storage device 80 is now discharging. The control unit 130 interprets this state to mean that the motor 150 must be switched off. Accordingly, using the power supplied by energy storage device 80, the control unit 130 causes the semiconductor switches 181 and 191 to switch to an electrically conductive state, then causes the electromechanical switches 182 and 192 to open, then causes the semiconductor switches 181 and 191 to switch to an electrically non-conductive state, and then causes the electromechanical switches 170 and 171 to open. In this way, the motor 150 can be safely disconnected from the power supply network 140 in a contact-friendly manner, even if the supply voltage UB fails.

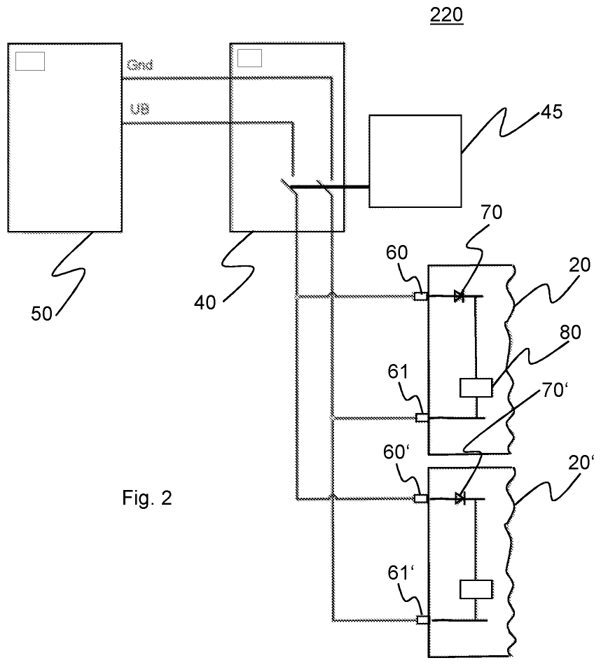

FIG. 2 shows a further exemplary safety switching system 220 which, in addition to the power supply source 50, the safety switch 40, and the emergency stop switch 45, for example, may comprise a plurality of switching apparatus, for example switching apparatus 20 and a further switching apparatus 20′. The further switching apparatus 20′ can preferably be configured substantially similar to the switching apparatus 20 and can be connected to the power supply network 140 and to an electrical load. Switching apparatus 20 and 20′ are connected in parallel to power supply source 50 via switching device 40.

In this case, in order to prevent the energy storage device 80 provided in the switching apparatus from being able to undesirably discharge to a parallel load, i.e. to the respective other switching apparatus, each switching apparatus 20 and 20′ includes the decoupling diode 70 and 70′, respectively, as shown in FIG. 1 and in FIG. 2. Expediently, as illustrated in FIGS. 1 and 2, the decoupling diodes 70 and 70′ are directly connected to the respective operating potential terminal 60 or 60′ of the third connection device of the respective switching apparatus.

1. A switching apparatus for safely disconnecting an electrical load from a power supply network, comprising:
a first connection device to which a power supply network for providing a supply voltage for an electrical load can be connected;
a second connection device to which an electrical load can be connected;
a third connection device to which a power supply source for providing a supply voltage for the switching apparatus can be connected;
at least one current path connected between the first and second connection devices, the at least one current path including a first electromechanical switch and, connected in series with the first electromechanical switch, a parallel circuit of a second electromechanical switch connected in parallel to a semiconductor switch;
a power supply unit electrically connected to the third connection device;
an energy storage device electrically connected to the third connection device in such a way that the energy storage device can be charged by a supply voltage that can be applied to the third connection device;
a control unit electrically connected to the power supply unit; wherein:
the control unit is configured to output a respective switching signal for the first electromechanical switch, the second electromechanical switch, and the semiconductor switch, wherein the control unit receives power for generating the switching signals via the power supply unit;
a detector and signaling device configured to detect discharging of the energy storage device and to supply a notification signal to the control unit signaling the control unit that the energy storage device is discharging, wherein the control unit is configured to be responsive to said notification signal by using the energy stored in the energy storage device to:
first switch the semiconductor switch to an electrically conductive state, then to open the second electromechanical switch, then to switch the semiconductor switch to an electrically non-conductive state, and then to open the first electromechanical switch.

2. The switching apparatus of claim 1, further comprising:
a voltage limiting device connected to the energy storage device, configured to limit the voltage applied to the energy storage device to a predetermined voltage value, wherein the energy storage device discharges when a supply voltage applied to the third connection device drops below the predetermined voltage value applied to the energy storage device.

3. The switching apparatus of claim 2, wherein:
the first connection device comprises a ground terminal and an operating potential terminal;
the voltage limiting device comprise a Zener diode and an electrical resistor, the Zener diode being connected in parallel to the energy storage device, wherein the anode terminal of the Zener diode is connected to the ground terminal and the cathode terminal is connected to a terminal of the electrical resistor, while the other terminal of the electrical resistor is associated with the operating potential terminal.

4. The switching apparatus as claimed in claim 1, wherein:
the detector and signaling device includes a coupling element connected to the energy storage device, to an input of the control unit, and to an input of the power supply unit, wherein the detector and signaling device supplies a binary notification signal.

5. The switching apparatus of claim 4, wherein:
the coupling element is an optocoupler comprising an optical transmitter connected between the energy storage device and the input of the power supply unit, and an optical receiver connected to the input of the control unit.

6. The switching apparatus as claimed in claim 1, further comprising:
a further current path connected between the first and second connection devices, which includes a first electromechanical switch and, connected in series with the first electromechanical switch, a parallel circuit of a second electromechanical switch connected in parallel to a semiconductor switch; wherein
the control unit is configured to output a respective switching signal for the first electromechanical switch, the second electromechanical switch, and the semiconductor switch of the further current path, wherein the control unit is furthermore configured, in relation to the further current path, to be responsive to said notification signal from the detector and signaling device by using the energy stored in the energy storage device to first switch the semiconductor switch to an electrically conductive state, then to open the second electromechanical switch, then to switch the semiconductor switch to an electrically non-conductive state, and then to open the first electromechanical switch.

7. A safety switching system for safely disconnecting an electrical load from a power supply network, comprising:
at least one switching apparatus according to claim 1; and
an external power supply source which can be connected to the third connection device of the at least one switching apparatus via an external switching device or can be disconnected from the third connection device of the at least one switching apparatus.

8. A safety switching system for safely disconnecting an electrical load from a power supply network, comprising:
a plurality of the switching apparatus according to claim 1, which can be connected in parallel to a power supply source via an external switching device, wherein each switching apparatus includes a decoupling diode, with an anode terminal thereof connected to the operating potential terminal of the third connection device and with a cathode terminal thereof connected to the power supply unit of the respective switching apparatus.
